(19) United States
(12) Patent Application Publication
(10) Pub. No.: US 2025/0007331 A1
(43) Pub. Date: Jan. 2, 2025

(54) COMMUNICATION SLOTS IN A WIRELESS POWER SYSTEM

(71) Applicant: GE Intellectual Property Licensing LLC, Niskayuna, NY (US)

(72) Inventors: Jayanti Ganesh, Bangalore (IN); Viswanathan Kanakasabai, Bangalore (IN); Subbarao Tatikonda, Bangalore (IN); Suma Memana Narayana Bhat, Bangalore (IN)

(21) Appl. No.: 18/755,551

(22) Filed: Jun. 26, 2024

(30) Foreign Application Priority Data
Jun. 28, 2023 (IN) 202311043250

(51) Int. Cl. H02J 50/80; H02J 50/10

(52) U.S. Cl. CPC H02J 50/80; H02J 50/10

(57) ABSTRACT

This disclosure provides systems, methods and apparatuses for a managing timing of communication slots in a wireless power system. The communication slots are centered on zero-cross instances. The Power Transmitter and/or Power Receiver can use a phase locked loop (PLL) to determine the timing of the zero-cross instances. The wireless power system can determine when to begin a communication slot based on the timing of the zero-cross instance and the slot width. For example, the beginning of the communication slot can begin at a time that is half the slot width before the time of the zero-cross instance.

### RELATED APPLICATIONS

This application claims priority benefit of India Provisional Patent Application No. 202311043250 filed Jun. 28, 2023.

### TECHNICAL FIELD

This disclosure relates generally to wireless power and some aspects relate to communication slots in a wireless power system.

### DESCRIPTION OF RELATED TECHNOLOGY

A wireless power system includes a Power Transmitter (PTx) and a Power Receiver (PRx). Inductive coupling can enable wireless power transfer between a primary coil of the Power Transmitter and a secondary coil of the Power Receiver. The primary coil of the Power Transmitter produces an electromagnetic field during a power state of the wireless power system. The electromagnetic field induces a voltage in the secondary coil of the Power Receiver when the secondary coil is present in the electromagnetic field. The Power Receiver can use the induced voltage (either directly or via a rectifier) to power a load. Example loads might include a motor, a heating element, electronics, or a power storage device, among other examples. In an example kitchen environment, a magnetic power source (such as a kitchen hob) might include one or more Power Transmitters. An appliance (such as a cordless kitchen appliance) might include a Power Receiver as well as the load. The appliance can be placed on a Power Transmitter such that the Power Receiver of the appliance can receive wireless power from the magnetic power source.

For a wireless power system to work effectively, the Power Transmitter and the Power Receiver communicate before and during a power transfer state (referred to as the power state). Example communications might include configuration, power negotiation, state control and power control messages, among other examples. During the power state, communication is limited to minimize interference with a wireless power signal. A communication slot refers to a period of time during the power state for communication to occur. To minimize disruption to the wireless power signal, the communication slots occur in relation to a zero-cross instance where the wireless power signal has less voltage. It is desirable to coordinate the timing of the communication slots with the timing of zero-cross instances.

### BRIEF SUMMARY

The systems, methods, and apparatuses of this disclosure each have several innovative aspects, no single one of which is solely responsible for the desirable attributes disclosed herein.

In one aspect, a method of a Power Transmitter, includes generating a wireless power signal for transmission to a Power Receiver based on an alternating current (AC) main power signal, determining a timing of a future zero-cross instance of the AC main power signal, calculating a start time for at least a first communication slot based on the timing of the future zero-cross instance and a duration (T_{Slot}) of the first communication slot such that approximately half of the T_{Slot} occurs before the future zero-cross instance, and configuring a communication unit to begin the first communication slot at the start time.

In one aspect, a Power Transmitter includes a driver circuit configured to generate a wireless power signal for transmission to a Power Receiver based on an alternating current (AC) main power signal. The Power Transmitter also includes a communication unit configured to communicate with the Power Receiver during one or more communication slots. The Power Transmitter also includes a controller configured to determine a timing of a future zero-cross instance of the AC main power signal, calculate a start time for at least a first communication slot based on the timing of the future zero-cross instance and a duration (T_{Slot}) of the first communication slot such that approximately half of the T_{Slot} occurs before the future zero-cross instance, and configure a communication unit to begin the first communication slot at the start time.

Details of one or more implementations of the subject matter described in this disclosure are set forth in the accompanying drawings and the description below. Other features, aspects, and advantages will become apparent from the description, the drawings, and the claims.

### BRIEF DESCRIPTION OF THE SEVERAL VIEWS OF THE DRAWINGS

Like reference numbers and designations in the various drawings indicate like elements. Note that the relative dimensions of the figures may not be drawn to scale.

FIG. 1 illustrates an example wireless power system.

FIG. 2 illustrates communication slots during a power state of the wireless power system.

FIG. 3A illustrates several examples of inconsistent timing of communication slots relative to zero-cross instances.

FIG. 3B illustrates additional examples of communication slots relative to zero-cross instances.

FIG. 4 illustrates an alternating current (AC) main power signal and the corresponding zero-cross instances.

FIG. 5 illustrates an example timing of communication slots centered on the zero-cross instances in accordance with aspects of this disclosure.

FIG. 6 illustrates an example relationship between the beginning of a communication slot based on the slot width and a zero-cross instance.

FIG. 7 illustrates an example phase-locked loop (PLL).

FIG. 8 illustrates the relationship between the phase of a PLL output and the zero-cross instances of an AC main power signal.

FIG. 9 illustrates a flow chart with example operations of a Power Transmitter.

FIG. 10 illustrates a block diagram of an example apparatus for use in a wireless power system.

### DETAILED DESCRIPTION

The following description is directed to certain implementations for the purpose of describing innovative aspects of this disclosure. However, a person having ordinary skill in the art will readily recognize that the teachings herein can be applied in a multitude of different ways. The described implementations can be implemented in any means, apparatus, system, or method for transmitting or receiving wireless power.

A wireless power system includes a Power Transmitter (PTx) and a Power Receiver (PRx). A Power Transmitter also may be referred to as a wireless power transmission apparatus. A Power Receiver also may be referred to as a wireless power reception apparatus. The wireless power system operates in accordance with communication between the Power Transmitter and the Power Receiver. Specifically, the Power Receiver and the Power Transmitter communicate using Near-Field Communication (NFC). During times (referred to as a power state) when a wireless power signal is being transmitted from a Power Transmitter to the Power Receiver, communication is limited to communication slots. The use of communication slots mitigates cross-interference, communication errors and power transfer efficiency losses that might otherwise occur by the concurrent transmission of the wireless power signal and the NFC communication signals. An alternating current (AC) main power is used to generate the wireless power signal. Because the voltage of the wireless power signal is lower (and therefore power transfer efficiency is lower) at the zero-cross instances, it is desirable for a wireless power system to coordinate timing of the communication slots in relation to the zero-cross instances. Furthermore, it might be desirable to adjust the duration (also referred to as a slot width) of the communication slots. Previous techniques for scheduling communication slots might depend on a slot width that is dependent on the frequency and/or amplitude of the AC main power signal.

This disclosure provides systems, methods, and apparatuses for a managing timing of communication slots in a wireless power system. Using the techniques of this disclosure, communication slots can be centered on zero-cross instances. Either or both of a Power Transmitter or Power Receiver can use a phase locked loop (PLL) to determine the timing of the zero-cross instance. The wireless power system can determine when to begin a communication slot based on the timing of the zero-cross instance and the slot width. For example, the beginning of the communication slot can begin at a time that is half the slot width before the time of the zero-cross instance. Thus, the communication slot can be centered on the zero-cross instance. Furthermore, while timing of the zero-cross instance is based on frequency of the AC main power signal, the slot width can be based on communication volume rather than characteristics of the AC main power signal.

Particular implementations of the subject matter described in this disclosure can be implemented to realize one or more of the following potential advantages. The use of a PLL to identify zero-cross instances enables the wireless power system to adjust to variations in the frequency of the AC main power signal while scheduling communication slots to occur at zero-cross instances. Advantageously, communication slots occur when power transfer is least efficient (at the zero-cross instances) while reducing the impact of communication slots during power transfer time where power transfer is more efficient. Furthermore, because the slot width can be set without dependence on the nature (such as frequency, voltage, or phase) of the AC main power signal, the slot width can be adjusted to enable sufficient communication time while also maximizing the power transfer time between successive communication slots.

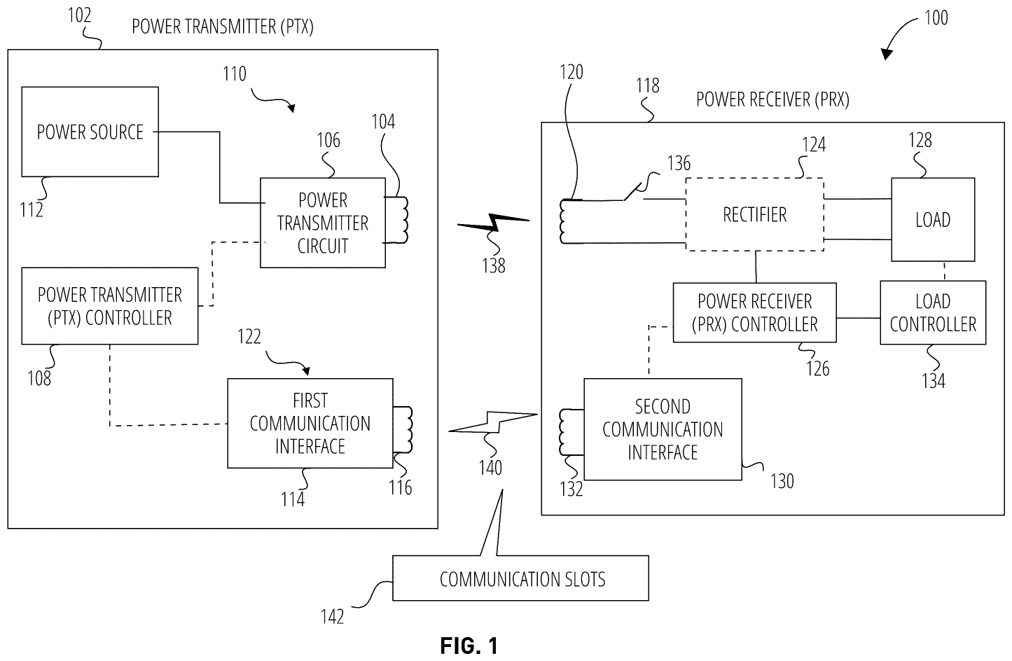

FIG. 1 illustrates an example wireless power system 100. The example wireless power system 100 includes a Power Transmitter 102 and a Power Receiver 118. In FIG. 1, dashed lines represent communications to distinguish from the solid lines that represent electrical circuit lines. In some implementations, the Power Transmitter 102 might be part of a magnetic power source such as a hob, a countertop, or range. For example, the Power Transmitter may include a surface-mounted primary coil, an integrated primary coil, a countertop-mounted primary coil, or a primary coil that is embedded or manufactured in a surface on which a Power Receiver can be placed. The Power Transmitter 102 includes a primary coil 104 configured to transmit wireless power. The Power Receiver 118 includes a secondary coil 120 configured to wirelessly receive power via inductive coupling with the primary coil 104 of the Power Transmitter 102. In some implementations, the Power Receiver 118 might be part of a cordless appliance such as a cordless blender, kettle, toaster, or cooking vessel, among other examples. Although some examples of this disclosure refer to a wireless power system in a kitchen environment, the disclosed techniques can be used with other types of wireless power systems or in other types of environments.

The primary coil 104 may be associated with a power transmitter circuit 106 (sometimes also referred to as a power signal generator, or a driver circuit, or a driver). The primary coil 104 may be a wire coil which transmits wireless power (which also may be referred to as wireless energy) via a wireless power signal 138. The primary coil 104 may transmit wireless energy using an inductive or a resonant magnetic field. The power transmitter circuit 106 may include components (not shown) to prepare the wireless power. For example, the power transmitter circuit 106 may include one or more switches, drivers, series capacitors, rectifiers, inverters, or other components. In some implementations, the power transmitter circuit 106, a PTx controller 108 and other components (not shown) may be collectively referred to as a power transmitter unit 110. Some or all of the power transmitter unit 110 may be embodied as an integrated circuit (IC) that implements features of this disclosure. The Power Transmitter 102 includes a PTx controller 108. The PTx controller 108 may be implemented as a microcontroller, dedicated processor, integrated circuit, application specific integrated circuit (ASIC) or any other suitable electronic device.

A power source 112 provides power to the power transmitter unit 110. In some implementations, the power source 112 may convert alternating current (AC) power to direct current (DC) power. For example, the power source 112 may include a converter that receives an AC power from an external power supply and converts the AC power to a DC power used by the power transmitter circuit 106. Alternatively, or additionally, a component (such as an inverter) of the power transmitter circuit 106 may convert the DC power to the AC power. The power source 112 may be integrated as part of the Power Transmitter 102 or may be external to the Power Transmitter 102. In some implementations, the Power Transmitter 102 causes the power source 112 to regulate the DC output voltage of the power source 112.

The PTx controller 108 is connected to a first communication interface 114. The first communication interface 114 is connected to a first communication coil 116. In some implementations, the first communication interface 114 and the first communication coil 116 may be collectively referred to as the first communication unit 122. In some implementations, the first communication unit 122 may support short-range radio frequency communication, such as Near-Field Communication (NFC) or Bluetooth (BT). NFC is a technology by which data transfer occurs on a carrier frequency of 13.56 Megahertz (MHz). The first communication unit 122 also may support any suitable communication protocol. The first communication unit 122 may contain modulation and demodulation circuits to transmit a communication signal 140 via the first communication coil 116. Alternatively, or additionally, the PTx controller 108 may use frequency, amplitude, current, or voltage modulation of the wireless power signal 138 to communicate via an in-band communication link (not shown) that includes the primary coil 104.

The Power Receiver 118 may include a secondary coil 120, a rectifier 124, a PRx controller 126, a second communication interface 130, a load controller 134, a load 128, and a memory (not shown). In some implementations, the load 128 can include a driver (not shown) for controlling at least one parameter such as charging current, speed, or torque of the load. In some implementations, the rectifier 124 may be omitted such as when the voltage induced in the secondary coil 120 can directly power the load 128. Although not shown, a load capacitance can be used after the rectifier 124 to filter the high frequency component of the rectifier voltage. Although shown as different components, some components may be packaged or implemented in the same hardware. For example, in some implementations, the PRx controller 126 and the load controller 134 may be implemented as a single controller. The PRx controller 126, the load controller 134, or any combination thereof, may be implemented as a microcontroller, dedicated processor, integrated circuit, application specific integrated circuit (ASIC) or any other suitable electronic device.

A PRx controller 126 may be operationally coupled to the rectifier 124 and the second communication interface 130. The second communication interface 130 may contain modulation and demodulation circuits to wirelessly communicate via the second communication coil 132. Thus, the PRx controller 126 may wirelessly communicate feedback information to the PTx controller 108 via the second communication interface 130 to the first communication interface 114 using short-range radio frequency communication, such as NFC. Alternatively, or additionally, the PRx controller 126 may use load modulation to communicate via an in-band communication link (not shown) that includes the secondary coil 120.

A load controller 134 may be operationally coupled to the load 128 and the second communication interface 130. The load controller 134 may detect changes to load states such as change in charging currents in a battery charging application. The load controller 134 also may determine a load voltage reference. The load controller 134 also may send load voltage references, load current, and any other suitable information to the PRx controller 126 or the second communication interface 130 for communication to the Power Transmitter 102. The PRx controller 126 may additionally determine and provide feedback information indicating a measured load voltage available to the load 128. In some feedback messages, the feedback information may include a reference voltage indicating a required voltage for the load 128, an error in the output voltage of the load 128, or the required power for the load. Although the PRx controller 126 and load controller 134 are shown separately, they may be included in the same component of the Power Receiver 118.

The wireless power system 100 operates in accordance with communication between the Power Transmitter 102 and the Power Receiver 118. Typically, the first communication interface 114 and the second communication interface 130 are implemented as NFC interfaces. The communication signal 140 includes one or more NFC signals from the first communication interface 114 to the second communication interface 130, and vice versa. While the wireless power signal 138 is active, the communication signal 140 might be limited to communication slots 142 to mitigate against cross-interference, communication errors and power transfer efficiency losses. During a power state, the Power Transmitter 102 applies the wireless power signal 138 for a duration of a power transfer time (T_{Power}) followed by a communication slot having a duration of T_{Slot} and then resumes transmission of the wireless power signal 138 for another duration of T_{Power}. The duration (T_{Slot}) of a communication slot is also referred to as a slot width. The communication slots 142 can be used for communication or foreign object detection (FOD). To prevent interference between the wireless power signal 138 and the communication signal 140, the communication slots 142 are scheduled in relation to zero-cross instances so that power level of the wireless power signal 138 is at a lowest amount when the communication signal 140 is active.

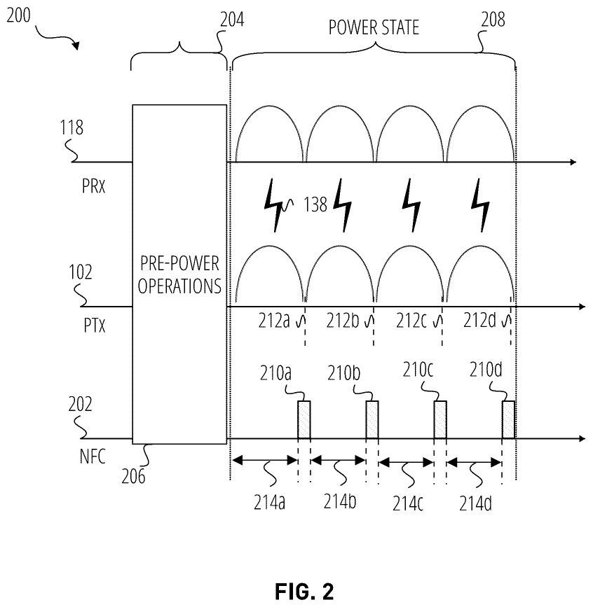

FIG. 2 illustrates communication slots during a power state of the wireless power system. A timing diagram 200 shows the timing of NFC communications (via communication channel 202) in relationship to various operating states. The Power Transmitter 102 and the Power Receiver 118 operate according to wireless power specification that defines the operating states. There can be four operating states associated with the wireless power system: a standby state (sometimes also referred to as a ping phase), a discovery state (sometimes referred to as an identification phase), a connected state, and a power state (sometimes referred to as a power transfer phase). The wireless power system typically begins in the standby state until the Power Transmitter detects a Power Receiver. In the discovery state, the Power Transmitter establishes communication and receives the first identification information of the Power Receiver and its static configuration data. In the connected state and the power state, the Power Transmitter and Power Receiver exchange information to agree and adjust parameters related to wireless power transfer. The system can move to a reinitialization state as needed to reinitialize or return to the standby state when communication, powering, or other activities are no longer taking place. The standby state, the discovery state, and the connected state are referred to as pre-power states 204 to distinguish them from the power state 208. The pre-power operations 206 might include a variety of communications associated with the pre-power states 204. The power state 208 is the operating state in which the Power Transmitter 102 transmits a wireless power signal 138 to the Power Receiver 118. Communication between the Power Transmitter 102 and the Power Receiver 118 can occur during the pre-power states 204 and the power state 208.

Specifically, during the power state 208, communication is performed during communication slots (such as communication slots 210a, 210b, 210c, and 210d). The communication slots occur in relation to zero-cross instances (such as zero-cross instances 212a, 212b, 212c, 212d) of an AC main power signal. The AC main power signal also provides timing for the wireless power signal 138. Therefore, zero-cross instances of the AC main power signal are concurrent with zero-cross instances of the wireless power signal 138. By scheduling the communication slots 210a, 210b, 210c, and 210d relative to the zero-cross instances 212a, 212b, 212c, 212d, the wireless power system can prevent some interference to the wireless power signal 138 and improve reliability of the communication signal 140 during the communication slots. The time between the communication slots can be referred to as power transfer time 214a, 214b, 214c, 214d (T_{Power}) because those are the periods during the Power Receiver 118 will utilize the wireless power signal 138.

A wireless power specification might define a minimum or nominal slot width. However, appliances or manufacturers might select different slot widths while satisfying the criteria in the wireless power specification. Furthermore, while the wireless power specification might require the communication slot to be at a zero-cross instance of the AC main power signal, it is possible that different appliances or manufacturers might begin the communication slot at different times relative to the zero-cross instance.

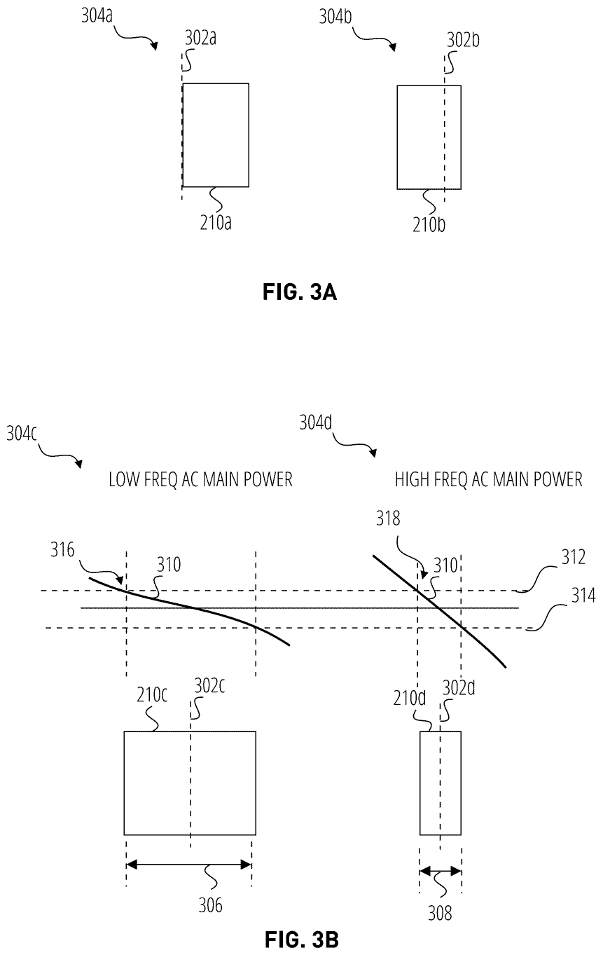

FIG. 3A illustrates several examples of inconsistent timing of communication slots relative to zero-cross instances. Different Power Transmitters or manufacturers might select a different timing or different slot width for the communication slots. FIG. 3A shows some examples of disparate communication slot timing relative to zero-cross instances 302a, 302b.

In the first example 304a, the communication slot 210a might begin at the zero-cross instance 302a. Therefore, most or all of the communication slot 210a is to the right of the zero-cross instance 302a. A disadvantage of this design is that the communication slot 210a might miss the zero-cross instance and the communication slot can interfere with the wireless power signal at a time when power transfer might be more efficient. The communication slot 210a reduces power transfer time to the right of the zero-cross instance 302a, and some of the wireless power signal to the left of the zero-cross instance 302a is less effective. Furthermore, there is a possibility of harmonics or other interference to the communication signal when the communication slot 210a overlaps the wireless power signal.

In the second example 304b, the communication slot 210b might begin before the zero-cross instance 302b. However, unless the communication slot 210b is centered on the zero-cross instance 302b, some communication time for the communication slot 210b could impact or be impacted by wireless power signal (not shown). In both examples of FIG. 3A, the communication slots 210a, 210b are not centered on the zero-cross instances 212a, 212b.

FIG. 3B illustrates additional examples of communication slots relative to zero-cross instances. In FIG. 3B, communication slots are initiated based on a voltage of the AC main power signal. For example, a communication slot might begin when the voltage of the AC main power signal 310 drops to a threshold 312 (such as 60 volts). The idea is that the communication slot occupies the time while the AC main power signal 310 is between +60 volts and −60 volts. However, as described with reference to FIG. 3B, such a technique can result in a communication slot width that is larger or smaller than desirable. Furthermore, because a frequency and voltage of AC main power signal 310 can change in some locations or even during power state at a same location, the communication slot width (duration T_{Slot}) might be dependent on the AC main power signal 310 rather than communication volume.

In a third example 304c, the AC main power signal 310 might have a lower frequency (compared to the fourth example 304d). The third example 304c shows an instance 316 when the AC main power signal 310 reaches the threshold 312 (such as 60 volts), marking the beginning of the communication slot 210c. The communication slot 210c continues until the AC main power signal 310 reaches −60 volts (at threshold 314). The slot width 306 of the communication slot 210c is larger than the communication slot 210d because the frequency of maximum voltage of the AC main power signal 310 in the third example 304c is lower than in the fourth example 304d.

In the fourth example 304d, the AC main power signal 310 has a higher frequency and the time period between the thresholds 312 and 314. Thus, the slot width 308 of the communication slot 210d is smaller compared to the communication slot 210c. The communication slot 210d begins at instance 318 when the AC main power signal 310 reaches the threshold 312 and ends when the AC main power signal 310 reaches the threshold 314.

While FIG. 3B shows communication slots 210c and 210d as being centered on the zero-cross instances 302c and 302d, respectively, the durations of the communication slots 210c and 210d are dependent on the frequency of the AC main power signal 310. However, the AC main power signal 310 might vary in frequency and voltage. For example, the AC main power signal 310 might have a nominal voltage of 230 V while actual voltages might range from 190V to 250V. When the voltage or frequency (or both) of the AC main power signal is lower, the duration (T_{Slot}) will be wider. Conversely, when the voltage or frequency (or both) is higher, the duration (T_{Slot}) will be smaller.

A disadvantage of this technique is that the duration of communication slots is dependent on the frequency and voltage of the AC main power signal. For example, when the AC main power signal is lower voltage, the communication slot is wider, reducing the available time (T_{Power}) for power transfer. Thus, not only is power transfer efficiency reduced due to low voltage of the AC main power signal, the T_{Power} is reduced due to unnecessarily large T_{Slot} (such as slot width 306). Conversely, when the voltage of the AC main power signal is high, the resulting T_{Slot} (such as slot width 308) may be too small to complete a communication between the Power Receiver and the Power Transmitter.

It is desirable to center the communication slot on the zero-cross instance while also supporting the variability of different slot widths for different implementations of the wireless power specification.

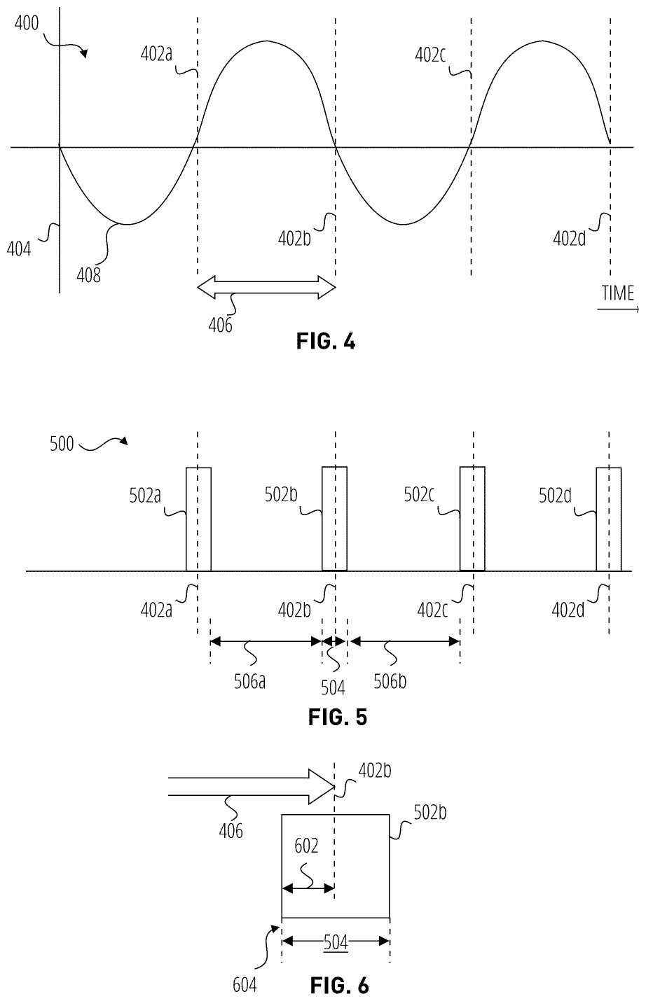

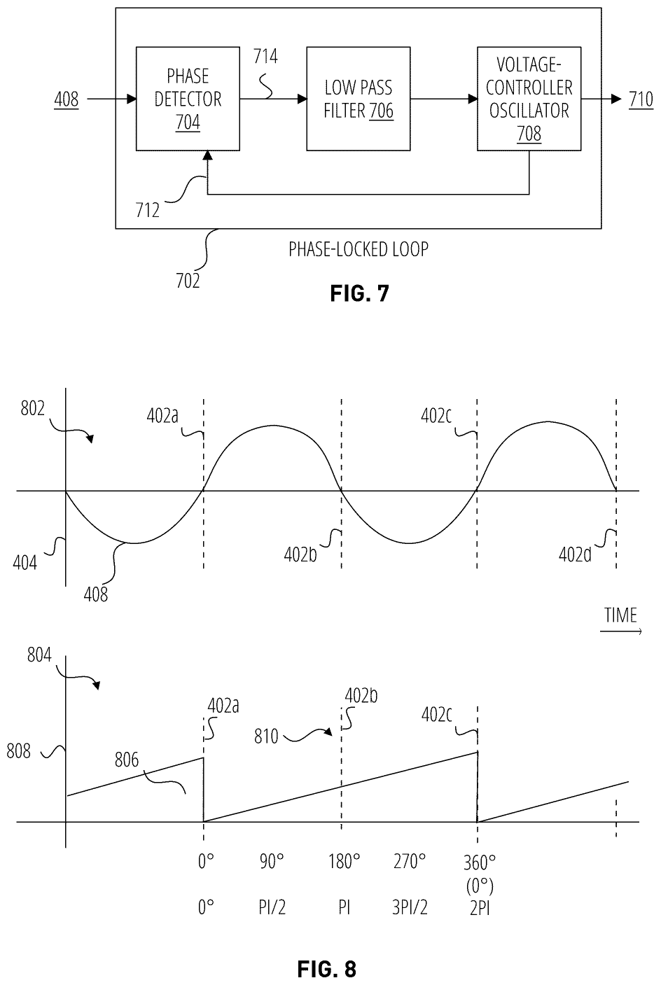

FIG. 4 illustrates an alternating current (AC) main power signal and the corresponding zero-cross instances. An AC main power waveform diagram 400 shows the voltage 404 of an AC main power signal 408 in relation to comprises a zero-cross instance 402a, zero-cross instance 402b, zero-cross instance 402c, and 402d. The time period 406 between zero-cross instances is a half cycle of the AC main power signal 408. As described with reference to FIG. 7, the timing of the zero-cross instance 402a, zero-cross instance 402b, zero-cross instance 402c, and 402d can be determined using a phase locked loop.

FIG. 5 illustrates an example timing of communication slots centered on the zero-cross instances in accordance with aspects of this disclosure. The communication timing diagram 500 shows the communication slots 502a, 502b, 502c, and 502d centered on the zero-cross instances 402a, 402b, 402c, and 402d, respectively. Referring to the communication slot 502b, half of the slot width 504 is before the zero-cross instance 402b and the other half of the slot width 504 is after the zero-cross instance 402b. Thus, the communication slot 502b is said to be centered on the zero-cross instance 402b because it is substantially divided half before and half after the zero-cross instance 402b.

A potential technical advantage of having the communication slot 502b centered on the zero-cross instance 402b is that the power transfer time 506a that occurs before the communication slot 502b is also centered on the peak voltage of the wireless power signal (not shown). The wireless power signal would have an AC cycle that is derived from (and has the same AC timing as) the AC main power signal 408 as described with reference to FIG. 4. Similarly, the communication slot 502b uniformly occurs at the lowest voltage areas of the wireless power signal so that power transfer time 506a and 506b are only interrupted by the communication slot 502b with substantially equal distribution before and after the zero-cross instance 402b. Thus, the communication slot 502b occurs during the lowest voltage periods of the wireless power signal. Furthermore, the duration (T Slot) of the communication slot 502b can have a slot width 504 that is not necessarily linked to the frequency or voltage of the wireless power system.

FIG. 6 illustrates an example relationship between the beginning of a communication slot based on the slot width and a zero-cross instance. As described with reference to FIG. 4 and FIG. 5, the communication slot 402b is centered on the zero-cross instance 402b. The zero-cross instance 402b is illustrated with a larger scale for illustration purposes.

A Power Transmitter can determine the timing of the zero-cross instance 402b based on the time period 406 since the previous zero-cross instance (not shown. A phase locked loop can sync to the frequency so that timing of the zero-cross instance 402b can be determined ahead of time. The Power Transmitter calculates the start time 604 of the communication slot 502b using half 602 of the slot width 504 before the zero-cross instance 402b.

FIG. 7 illustrates an example phase-locked loop (PLL). A PLL is a control system that generates an output signal whose phase is related to the phase of an input signal. In the example PLL of FIG. 7, the AC main power signal 408 serves as an input signal to the phase-locked loop 702. The phase-locked loop 702 includes a phase detector 704, a low pass filter 706, and a voltage-controller oscillator 708 in a feedback loop. At the input, the phase detector 704 compares two input signals (the AC main power signal 408 and the feedback signal 712) and produces an error signal 714 that is proportional to their phase difference. The error signal 714 is then passed through the low pass filter 706 and used to drive the voltage-controller oscillator 708. The voltage-controller oscillator 708 generates an output signal 710. The output signal 710 is also fed back as a feedback signal 712. If the output phase of the output signal 710 drifts, the error signal 714 will increase, driving the voltage-controller oscillator 708 phase in the opposite direction so as to reduce the error. Thus, the phase of the output signal 710 is locked to the phase of the AC main power signal 408.

The output signal 710 indicates a phase value that changes in relation to a phase of the AC main power signal. Different instants of the AC main power signal have different phase values. For example, as the AC main power signal goes through the AC cycle, each moment will correspond to a different phase value. The AC cycle can be a sine wave that oscillates such that instantaneous voltage fluctuates according to a cycle. Each moment of the cycle can be represented by a phase value (referred to as phase for brevity). One full cycle of a sine wave has a total of 360 degrees, which his equivalent to 2π radians.

FIG. 8 illustrates the relationship between the phase of a PLL output and the zero-cross instances of an AC main power signal. The top part of FIG. 8 illustrates an AC main power waveform diagram 802. The AC main power waveform diagram 802 shows the voltage 404 of the AC main power signal 408 over time. The AC main power waveform diagram 802 also shows the zero-cross instances 402a, 402b, 402c, and 402d as described with reference to FIG. 4.

The bottom part of FIG. 8 illustrates a phase plot diagram 804 in relation to the AC main power waveform diagram 802. The phase plot diagram 804 shows the phase 806 of the AC main power signal 408 in relation to the phase values 808 associated with different moments of the AC main power signal 408. At the zero-cross instance 402a, the AC main power signal 408 is at the beginning of the sine wave. The corresponding phase value is zero degrees (0°), which is equivalent to zero (0) radians. When the sine wave is at its peak (between the zero-cross instance 402a and the zero-cross instance 402b), the corresponding phase value is 90°, which is equivalent to π/2. At the zero-cross instance 402b, the sine save is crossing from positive voltage to negative voltage and would have no voltage at that moment of the zero-cross instance 402b. The corresponding phase value at the zero-cross instance 402b is 180°, which is equivalent to π. Continuing with the phase plot diagram 804, when the sine wave is at the lowest value, the phase value is 270°, which is equivalent to 3π/2. Finally, when the sine wave returns to the zero-cross instance 402c, the phase value is 360°, which is equivalent to 2π. Note that because a phase of 360° (2π) is also the beginning of the sine wave, the phase value can be referred to as zero (0).

A PLL (such as the phase-locked loop 702 described with reference to FIG. 7) can lock onto the phase of the AC main power signal 408 and continuously output the phase value based on where the AC main power signal 408 is in the sine wave. For example, the output of the PLL can be a signal having the same phase as the AC main power signal 408 or can be a value in radians or degrees. As every sine wave has 360 degree cycle, and the frequency is known based on the PLL, then starting of the slot can be fixed at a certain degree angle and stopped at a certain degree angle to keep the a consistent communication slot duration that is centered on the zero-cross instance. The start and stop degree angle can be chosen to be same degree angle away from the zero cross event to keep zero crossing centered. A duration of a half cycle of the AC main power signal can be calculated or measured based on a period in which the output of the PLL changes from zero (0) to π radians or from π to 2π radians. Furthermore, an occurrence of a previous zero-cross instance can be detected when the output of the PLL is 0, π, or 2π radians. By measuring the duration of a half cycle and detecting the previous zero cross instance, a Power Transmitter can calculate the timing of the next zero-cross instance. For example, the Power Transmitter might measure the duration between the zero-cross instance 402a and the zero-cross instance 402b based on the time when the output of the PLL changes from 0 to π radians. Then, the next zero cross instance (the zero-cross instance 402c in this example) would be the duration of the half cycle after the occurrence of the zero-cross instance 402b.

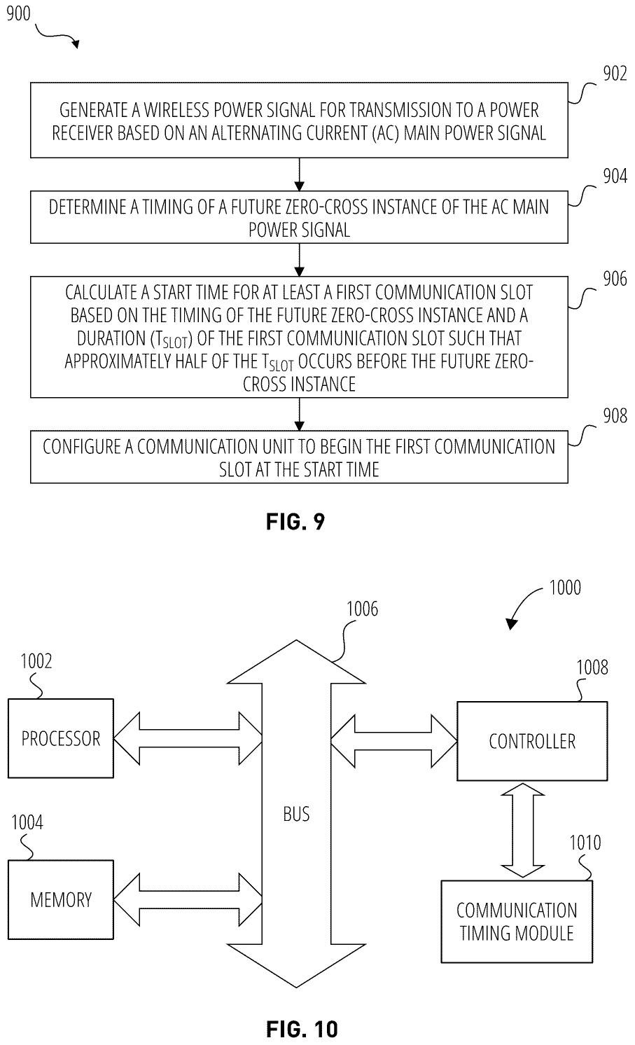

FIG. 9 illustrates a flow chart with example operations 900 of a Power Transmitter. For example, the operations 900 might be performed by the Power Transmitter 102 described with reference to FIG. 1.

In block 902, the Power Transmitter generates a wireless power signal for transmission to a Power Receiver based on an alternating current (AC) main power signal. In block 904, the Power Transmitter determines the timing of a future zero-cross instance of the AC main power signal. In block 906, the Power Transmitter calculates a start time for at least a first communication slot based on the timing of the future zero-cross instance and a duration (T_{Slot}) of the first communication slot such that approximately half of the T_{Slot} occurs before the future zero-cross instance. In block 908, the Power Transmitter configures a communication unit to begin the first communication slot at the start time.

FIG. 10 illustrates a block diagram of an example apparatus for use in a wireless power system. In some implementations, the apparatus 1000 may be a wireless power apparatus (such as the Power Transmitter 102 described with reference to FIG. 1). The apparatus 1000 can include a processor 1002 (possibly including multiple processors, multiple cores, multiple nodes, or implementing multi-threading, among other examples). The apparatus 1000 also can include a memory 1004. The memory 1004 may be system memory or any one or more of the possible realizations of computer-readable media described herein. The apparatus 1000 also can include a bus 1006 (such as PCI, ISA, PCI-Express, HyperTransport®, InfiniBand®, NuBus®, AHB, AXI, etc.).

The memory 1004 can include computer instructions executable by the processor 1002 to implement the functionality of the implementations described herein. Any one of these functionalities may be partially (or entirely) implemented in hardware or on the processor 1002. For example, the functionality may be implemented with an application specific integrated circuit, in logic implemented in the processor 1002, in a co-processor on a peripheral device or card, etc. Further, realizations may include fewer or additional components not illustrated in FIG. 10. The processor 1002, the memory 1004, and the controller 1008 may be coupled to the bus 1006. Although illustrated as being coupled to the controller 1008, the memory 1004 may be coupled to the processor 1002.

The apparatus 1000 may include one or more controllers 1008. In some implementations, the controller 1008 can be distributed within the processor 1002, the memory 1004, and the bus 1006. The controller 1008 may perform some or all of the operations described herein.

In some implementations, the apparatus 1000 includes a communication timing module 1010. In some implementations, the communication timing module 1010 includes a PLL (such as the phase-locked loop 702 described with reference to FIG. 7). The communication timing module 1010 might include logic, instructions, or circuitry to measure a duration of at least a half cycle of the AC main power signal based on an output of the PLL. In some implementations, the communication timing module 1010 also detects occurrences of each zero-cross instance and calculates a timing for the next zero-cross instance based on the duration of the prior half cycle.

FIG. 1 through FIG. 10 and the operations described herein are examples meant to aid in understanding example implementations and should not be used to limit the potential implementations or limit the scope of the claims. Some implementations may perform additional operations, fewer operations, operations in parallel or in a different order, and some operations differently.

The foregoing disclosure provides illustration and description but is not intended to be exhaustive or to limit the aspects to the precise form disclosed. Modifications and variations may be made in consideration of the above disclosure or may be acquired from practice of the aspects. While the aspects of the disclosure have been described in terms of various examples, any combination of aspects from any of the examples is also within the scope of the disclosure. The examples in this disclosure are provided for pedagogical purposes. Alternatively, or in addition to the other examples described herein, examples include any combination of the following implementation options (identified as clauses for reference).

### CLAUSES

Clause 1. A method of a Power Transmitter, including: generating a wireless power signal for transmission to a Power Receiver based on an alternating current (AC) main power signal; determining a timing of a future zero-cross instance of the AC main power signal; calculating a start time for at least a first communication slot based on the timing of the future zero-cross instance and a duration (T_{Slot}) of the first communication slot such that approximately half of the T_{Slot} occurs before the future zero-cross instance; and configuring a communication unit to begin the first communication slot at the start time.

Clause 2. The method of clause 1, where determining the timing of the future zero-cross instance includes: calculating the timing of the future zero-cross instance based on an amount of time between a half cycle of the AC main power signal and a previous zero-cross instance.

Clause 3. The method of clause 1 or 2, further including: locking onto a frequency of the AC main power signal using a phase locked loop (PLL), where a phase output of the PLL indicates a phase value that changes in relation to a phase of the AC main power signal; and determining the timing of the future zero-cross instance based on an output of the PLL.

Clause 4. The method of clause 3, where determining the timing of the future zero-cross instance includes: measuring duration of at least a prior half cycle of the AC main power signal based on a period in which the phase output of the PLL changes from zero (0) to π radians or from π to 2π radians; detecting an occurrence of a previous zero-cross instance when the output of the PLL is 0, π, or 2π radians; and calculating the timing of the future zero-cross instance based on the duration of at least the prior half cycle and the occurrence of the previous zero-cross instance.

Clause 5. The method of any one of clauses 1 to 4, further including: determining the T_{Slot} based on an amount and periodicity of information to communicate to the Power Receiver.

Clause 6. The method of any one of clauses 1 to 5, where the duration of the first communication slot is not dependent on a voltage and frequency of the AC main power signal.

Clause 7. The method of any one of clauses 1 to 6, further including: communicating with the Power Receiver during one or more communication slots, where the one or more communication slots are centered on one or more corresponding zero-cross instances based on a slot width of the one or more communication slots.

Clause 8. A Power Transmitter including: a driver circuit configured to generate a wireless power signal for transmission to a Power Receiver based on an alternating current (AC) main power signal; a communication unit configured to communicate with the Power Receiver during one or more communication slots; and a controller configured to: determine a timing of a future zero-cross instance of the AC main power signal; calculate a start time for at least a first communication slot based on the timing of the future zero-cross instance and a duration (T_{Slot}) of the first communication slot such that approximately half of the T_{Slot} occurs before the future zero-cross instance; and configure the communication unit to begin the first communication slot at the start time.

Clause 9. The Power Transmitter of clause 8, where the controller is configured to: calculate the timing of the future zero-cross instance based on an amount of time between a half cycle of the AC main power signal and a previous zero-cross instance.

Clause 10. The Power Transmitter of clause 8 or 9, further including: a phase locked loop (PLL) configured to lock onto a frequency of the AC main power signal, where a phase output of the PLL indicates a phase value that changes in relation to a phase of the AC main power signal, and where the controller is configured to determine the timing of the future zero-cross instance based on the phase output of the PLL.

Clause 11. The Power Transmitter of any one of clauses 8 to 10, where the controller is configured to: measure duration of at least a prior half cycle of the AC main power signal based on a period in which the output of the PLL changes from zero (0) to π radians or from π to 2π radians; detect an occurrence of a previous zero-cross instance when the output of the PLL is 0, π, or 2π radians; and calculate the timing of the future zero-cross instance based on the duration of at least the prior half cycle and the occurrence of the previous zero-cross instance.

Clause 12. The Power Transmitter of any one of clauses 8 to 11, where the controller is configured to determine the T_{Slot} based on an amount and periodicity of information to communicate to the Power Receiver.

Clause 13. The Power Transmitter of any one of clauses 8 to 12, where the T_{Slot} is not dependent on the voltage and frequency of the AC main power signal.

Clause 14. The Power Transmitter of any one of clauses 8 to 13, where the controller is configured to: cause the communication unit to communicate with the Power Receiver during one or more communication slots, where the one or more communication slots are centered on one or more corresponding zero-cross instances based on a slot width of the one or more communication slots.

Another innovative aspect of the subject matter described in this disclosure can be implemented as a computer-readable medium having stored therein instructions which, when executed by a processor, causes the processor to perform any one of the above-mentioned functionalities.

Another innovative aspect of the subject matter described in this disclosure can be implemented as a system having means for implementing any one of the above-mentioned functionalities.

Another innovative aspect of the subject matter described in this disclosure can be implemented as an apparatus having one or more processors configured to perform one or more operations from any one of the above-mentioned methods.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus used to implement the various illustrative components, logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination of computing devices, for example, a combination of a DSP and a microprocessor, multiple microprocessors, one or more microprocessors in conjunction with a DSP core, or any other such configuration. In some implementations, particular processes, operations and methods may be performed by circuitry that is specific to a given function.

As described above, some aspects of the subject matter described in this specification can be implemented as software. For example, various functions of components disclosed herein, or various blocks or steps of a method, operation, process or algorithm disclosed herein can be implemented as one or more modules of one or more computer programs. Such computer programs can include non-transitory processor-executable or computer-executable instructions encoded on one or more tangible processor-readable or computer-readable storage media for execution by, or to control the operation of, a data processing apparatus including the components of the devices described herein. By way of example, and not limitation, such storage media may include RAM, ROM, EEPROM, CD-ROM or other optical disk storage, magnetic disk storage or other magnetic storage devices, or any other medium that may be used to store program code in the form of instructions or data structures. Combinations of the above should also be included within the scope of storage media.

Various modifications to the implementations described in this disclosure may be readily apparent to persons having ordinary skill in the art, and the generic principles defined herein may be applied to other implementations without departing from the scope of this disclosure. Thus, the claims are not intended to be limited to the implementations shown herein but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

What is claimed is:

1. A method of a Power Transmitter, comprising:
generating a wireless power signal for transmission to a Power Receiver based on an alternating current (AC) main power signal; and
communicating with the Power Receiver during one or more communication slots, wherein the one or more communication slots are centered on one or more corresponding zero-cross instances based on a slot width of the one or more communication slots.

2. The method of claim 1, further comprising:
determining a timing of a future zero-cross instance of the AC main power signal;
calculating a start time for at least a first communication slot based on the timing of the future zero-cross instance and the slot width of the first communication slot such that approximately half of the slot width occurs before the future zero-cross instance; and
configuring a communication unit to begin the first communication slot at the start time.

3. The method of claim 2, wherein determining the timing of the future zero-cross instance includes:
calculating the timing of the future zero-cross instance based on an amount of time between a half cycle of the AC main power signal and a previous zero-cross instance.

4. The method of claim 1, further comprising:
locking onto a frequency of the AC main power signal using a phase locked loop (PLL), wherein a phase output of the PLL indicates a phase value that changes in relation to a phase of the AC main power signal; and
determining a timing of the one or more corresponding zero-cross instances based on an output of the PLL.

5. The method of claim 4, wherein determining the timing of the one or more corresponding zero-cross instances includes:
measuring a duration of at least a prior half cycle of the AC main power signal based on a period in which the phase output of the PLL changes from zero (0) to π radians or from π to 2π radians;
detecting an occurrence of a previous zero-cross instance when the output of the PLL is 0, π, or 2π radians; and
calculating the timing of the one or more corresponding zero-cross instances based on the duration of at least the prior half cycle and the occurrence of the previous zero-cross instance.

6. The method of claim 1, further comprising:
determining the slot width based on an amount and periodicity of information to communicate to the Power Receiver.

7. The method of claim, wherein a duration of the first communication slot is not dependent on a voltage and frequency of the AC main power signal.

8. A Power Transmitter comprising:
a driver circuit configured to generate a wireless power signal for transmission to a Power Receiver based on an alternating current (AC) main power signal; and
a communication unit configured to communicate with the Power Receiver during one or more communication slots, wherein the one or more communication slots are centered on one or more corresponding zero-cross instances based on a slot width of the one or more communication slots.

9. The Power Transmitter of claim 8, further comprising:
a controller configured to:
determine a timing of a future zero-cross instance of the AC main power signal;
calculate a start time for at least a first communication slot based on the timing of the future zero-cross instance and the slot width of the first communication slot such that approximately half of the slot width occurs before the future zero-cross instance; and
configure the communication unit to begin the first communication slot at the start time.

10. The Power Transmitter of claim 9, wherein the controller is configured to:
calculate the timing of the future zero-cross instance based on an amount of time between a half cycle of the AC main power signal and a previous zero-cross instance.

11. The Power Transmitter of claim 8, further comprising:
a phase locked loop (PLL) configured to lock onto a frequency of the AC main power signal, wherein a phase output of the PLL indicates a phase value that changes in relation to a phase of the AC main power signal, and wherein the controller is configured to determine a timing of the one or more corresponding zero-cross instances based on the phase output of the PLL.

12. The Power Transmitter of claim 8, wherein the controller is configured to:
measure a duration of at least a prior half cycle of the AC main power signal based on a period in which the output of the PLL changes from zero (0) to π radians or from π to 2π radians;
detect an occurrence of a previous zero-cross instance when the output of the PLL is 0, π, or 2π radians; and
calculate the timing of the one or more corresponding zero-cross instances based on the duration of at least the prior half cycle and the occurrence of the previous zero-cross instance.

13. The Power Transmitter of claim 8, wherein the controller is configured to determine the slot width based on an amount and periodicity of information to communicate to the Power Receiver.

14. The Power Transmitter of claim 8, wherein the slot width is not dependent on a voltage and frequency of the AC main power signal.
